(19) United States
(12) Patent Application Publication
(10) Pub. No.: US 2015/0013619 A1
(43) Pub. Date: Jan. 15, 2015

(54) PET LEASH BELT DEVICE

(71) Applicant: Robert J. Kahana, JR., Franklinville, NJ (US)

(72) Inventor: Robert J. Kahana, JR., Franklinville, NJ (US)

(21) Appl. No.: 14/327,360

(22) Filed: Jul. 9, 2014

Related U.S. Application Data
(60) Provisional application No. 61/844,263, filed on Jul. 9, 2013.

(51) Int. Cl. A01K 1/04; A41F 9/00; A01K 27/00

(52) U.S. Cl. CPC A01K 1/04; A01K 27/003; A41F 9/002
USPC 119/770; 119/769

(57) ABSTRACT

The pet leash belt system leash providing a waist belt worn by pet owners and featuring a sliding ring mechanism on which the wearer secures a standard pet leash, thus affording the wearer a hands-free means of walking their animal while also affording the animal freedom of movement about their owner.

### CLAIM OF PRIORITY

This patent application claims priority under 35 USC 119 (e) (1) from U.S. Provisional Patent Application Ser. No. 61/844,263 filed Jul. 9, 2013, of common inventorship herewith entitled, “Pet Leash.”

### BACKGROUND OF THE INVENTION

1. Field of the Invention

This invention relates generally to a pet leash and, more particularly, the invention relates to a pet leash providing a waist belt worn by pet owners and featuring a clip mechanism on which the wearer secures a standard pet leash, thus affording the wearer a hands-free means of walking their animal while also affording the animal 360 degrees freedom of movement about their owner.

2. Description of the Prior Art

A favorite pastime enjoyed by many dog owners, as well as their pets, is taking a leisurely or fast paced walk. Breathing in the fresh air, stretching the body with some light exercise, and enjoying the sights and sounds of new surroundings, taking an outdoor walk can be a revitalizing experience for both the animal and their owner. Typically, most dogs, regardless of whether an expensive thoroughbred purchased from a top notch breeder, or a mixed breed “mutt” picked up at the local pound, love going for walks. Not surprisingly, many dog owners report that their pets instinctively run for the door as soon as they see that their masters have grabbed their leash. When walking their animal, many pet owners often experience the frustrating scenario of attempting to restrain their animal and keep them directly by their side. While teaching a dog to “heel” is an important component of dog training, many pet owners appreciate the free spirited nature of their animals and thus allow their dogs to freely roam about in order to explore their surroundings. Unfortunately, should the dog run back and forth or around their owner, the result can be that they themselves or their owner becomes hopelessly entangled in the pet leash. Not only presenting tripping hazards to the animal, when this occurs, the pet owner themselves can be subject to accidents or injury. As can be imagined, falling flat on hard pavement, simply because one has accidentally tripped over their pet's leash can be a very frustrating and painful experience.

### BRIEF DESCRIPTION OF THE DRAWINGS

FIG. 1 is a front perspective view illustrating a pet leash belt device, constructed in accordance with the present invention.

FIG. 2 is a front view of a user wearing the pet leash belt device of the present invention with a dog attached to the end of the leash showing hands free.

FIG. 3 is a close up front perspective view of the ring attached to a mounting plate, and the mounting plate travels inside the track of the belt.

FIG. 4 is a cross sectional view of the track shown in FIG. 3.

FIG. 5 is a cross sectional view of a track of an alternative embodiment of the present invention.

FIG. 6. Is a side view of a ball and pin that fits into the track shown in FIG. 5 and is attached to the ring mounting plate.

### SUMMARY OF THE INVENTION

It is an object of the present invention to provide a pet leash belt system leash providing a waist belt worn by pet owners and featuring a sliding ring mechanism on which the wearer secures a standard pet leash, thus affording the wearer a hands-free means of walking their animal while also affording the animal 360 degrees freedom of movement about their owner.

It is a further object of the present invention to provide a pet leash belt system leash providing a waist belt worn by pet owners and featuring a sliding ring mechanism on which the wearer secures a standard pet leash, thus affording the wearer a hands-free means of walking their animal while also affording the animal 360 degrees freedom of movement about their owner in addition to up and down freedom of movement.

### DETAILED DESCRIPTION OF THE PREFERRED EMBODIMENTS

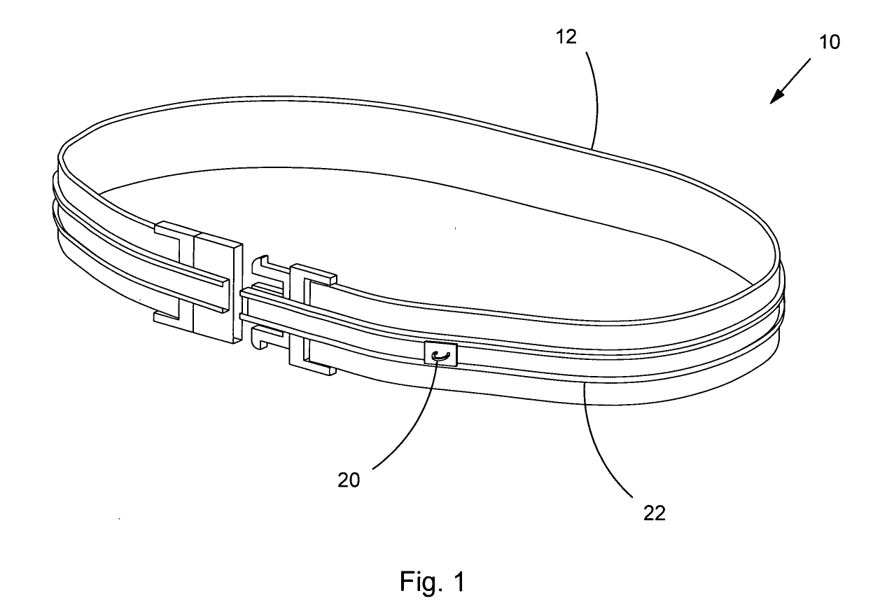

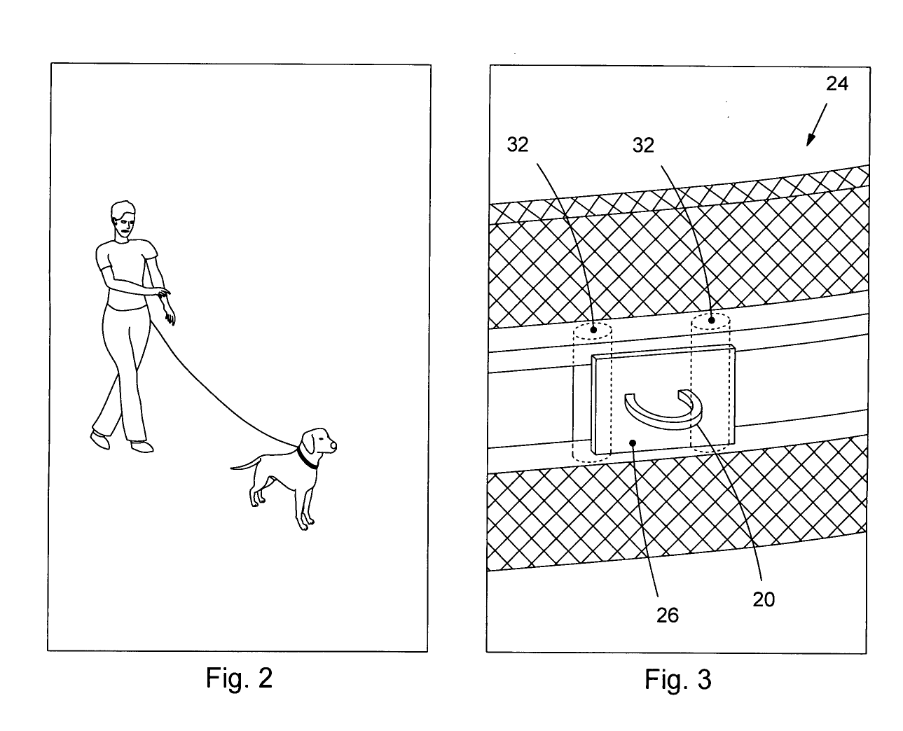

As illustrated in FIGS. 1-6 the present invention is a pet leash belt 10 providing a waist belt 12 worn by pet owners and featuring a track 22 and sliding ring mechanism 20 (shown in FIGS. 3 and 6) on which the wearer secures a standard pet leash, thus affording the wearer a hands-free means of walking their animal while also affording the animal 360 degrees freedom of movement about their owner, and in an alternative embodiment, up and down freedom of movement as well.

The pet leash belt of the present invention is constructed of a double stitched and reinforced nylon material. The pet leash belt can be similar in appearance to a standard adjustable belt and is a one-piece, strap-like device comfortably held about the waist via a sturdy buckle or interlocking clip closure. The leash belt can also be sized appropriately to be worn about the wrist, while larger versions for use in anchoring the leash around a tree or post could also be made available. The pet leash belt can be produced in a range of sizes and widths to accommodate various body types and wearers, as well as in a variety of attractive colors and neutral hues.

Most notably, extending the entire length of the belt 12 is a sturdy channel-like track 22 in which a slider 24 freely moves along the track 22 and is securely attached thereto. The sliding mechanism comprises mounting plate 26, ring 20 and slider 24. Slider 24 travels inside track 22. Slider 24 is attached to the underside of mounting plate 26, and ring 20 is attached to the top side of mounting plate 26.

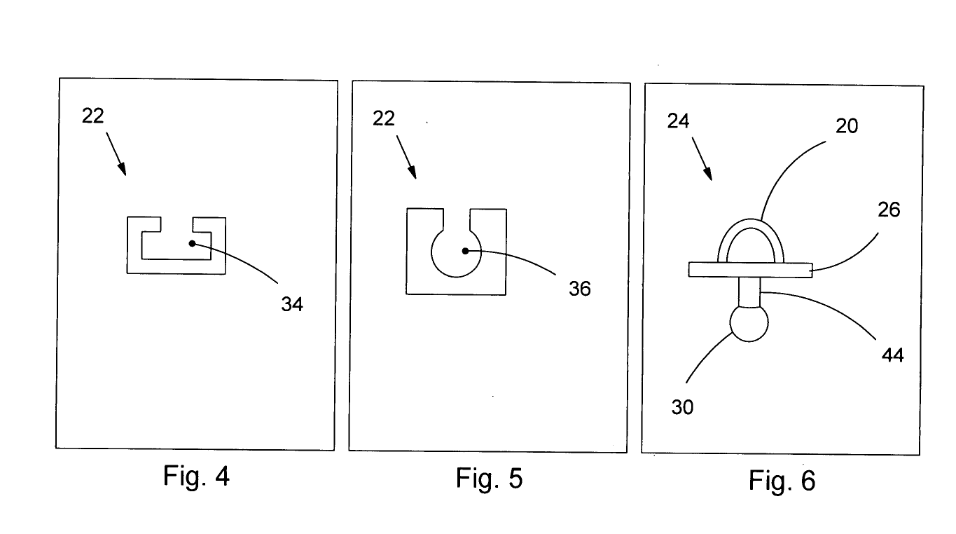

In one specific embodiment, shown in FIGS. 3 and 4, slider 24 comprises two parallel cylindrical members 32, which travel inside the track 22 and the inside shape of the track is rectangular 34, wherein the two parallel cylindrical members 32 are oriented vertically inside the track 22. The underside of mounting plate 26 is attached directly to the two parallel cylindrical members 32. Ring 20 is attached to the top side of mounting plate 26.

In an alternative specific embodiment, shown in FIGS. 5 and 6, the slider 24 comprises a ball 30 which travels inside track 22 and the inside shape of the track is round 36 to accommodate more than half the circumference of the ball 30 to secure the ball 30 in the track 22. In this embodiment, ball 30 is attached to the underside of mounting plate 26 by means of a short pin or rod 44. Again, ring 20 is attached to the top side of mounting plate 26.

The ring 20 is a small, circular shaped looped holder on which the user secures the animal's leash. Ring 20 can also comprise a “D” ring. The pet leash belt can be used in conjunction with an existing pet leash, simply by applying a spring loaded or hinged clip to the leash's handle, or the user might utilize a leash configured specifically for use on the pet leash belt and having clips or hook fasteners on both ends of the leash; one for the attaching the leash to the belt, while the opposite is be secured to the animal's collar.

Use of the pet leash belt of the present invention is very simple and straight forward. First, the dog lover purchases the leash sized appropriately for their body. Alternately, the user might purchase a leash to be worn about the wrist, while those who keep their dog tethered outdoors might purchase one large enough to be secured about a tree trunk or post. In the case of the belt version, the user dons the leash as they would any other belt, securing the unit via a buckle or clip closure, about their natural waist. Similarly, a wrist version can be applied about the wrist in the same fashion, while one to be applied about a tree trunk or post is wrapped about the designated object and locked into place via the buckle or clip fasteners. Next, the user attaches the end of their pet's leash to the clip mechanism, integrally attached to the sliding mechanism which traverses the unit's channel-like track. Once the animal's leash is secured to the belt, the user secures the opposite end of the leash to their pet's collar, and they are ready to go for a stroll. In this manner, once the pet's leash is secured to the leash belt, the animal freely roams the entire area around the wearer's body, while still being securely tethered to their leash. While walking, the owner enjoys the hands-free convenience of the leash, while the dog freely roams about either side, in front or behind their owner, securely tethered to this unique waist belt. For those dogs tethered outside, the leash enables the animal to freely roam 360 degrees about the tree or post on which they are secured, thus facilitating easy and comfortable movement while preventing the animal from becoming tangled in their lead. After use, the owner unleashes their animal, removes the leash and stores the unit away until again needed.

The pet leash belt of the present invention offers users a number of significant benefits and advantages. Foremost, the leash offers dog lovers a simple, hands-free means of walking their pet. Users will appreciate that simply by donning the leash about their waist and securing their pet's leash to the moveable clip mechanism, they enjoy a leisurely stroll with their pet, while safely walking their animal. Eliminating the need to continuously pass a leash back and forth between the hands, simply in order to alleviate the strain associated with holding the leash or to satisfy the directional demands of the animal, the leash enables the dog owner to walk their pet in comfort and with ease. Further, pets secured to the leash enjoy the freedom that this unique waist belt allows. Enabling the animal free range to roam on either side, behind or in front of the owner, the leash proves a favorite commodity of both the owner and their pet. Further, those pet owners who prefer to allow their animal to enjoy the outdoors by tethering them to a tree or post will especially appreciate that with the leash belt, their beloved pooch never again becomes hopelessly entangled in a leash or wrapped about a tree when unattended. Truly versatile, the pet leash belt is ideal for use with virtually any size dog, regardless if one owned a Miniature Schnauzer, a Boxer or even a St. Bernard. Further, the owners of exotic pets including ferrets, rabbits and the like will appreciate the many benefits the leash affords.

Practical and unique, the pet leash belt offers dog owners a comfortable, hands-free means of walking their pet. Comfortable to wear, this easily donned waist belt or wrist band proves a favorite commodity of any pet lover.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein may be suitably practiced in the absence of the specific elements which are disclosed herein.

1. A pet leash belt device comprising:
an adjustable belt and sturdy buckle or interlocking clip closure, further comprising a channel-like track extending the entire length of the belt, wherein the channel like track is capable of receiving a sliding mechanism and the sliding mechanism comprises a slider, which traverses the track, a mounting plate which is attached to the slider and a ring, which is attached to the mounting plate, wherein the slider is attached to an underside of the mounting plate, and the ring is attached to a top side of mounting plate.

2. The pet leash belt of claim 1 wherein the slider comprises two parallel cylindrical members, which travel inside the track and the inside shape of the track is rectangular, further wherein the two parallel cylindrical members are oriented vertically inside the track, wherein the underside of mounting plate is attached directly to the two parallel cylindrical members.

3. The pet leash belt of claim 1 wherein the slider comprises a ball which travels inside track and the inside shape of the track is round to accommodate more than half the circumference of the ball to secure the ball in the track, further wherein the ball is attached to the underside of mounting plate by means of a short pin or rod.

4. The pet leash belt of claim 1 wherein the ring is a “D” ring.

5. The pet leash belt of claim 2 wherein the ring is a “D” ring.

6. The pet leash belt of claim 3 wherein the ring is a “D” ring.

7. The pet leash belt of claim 1 further comprising a leash configured specifically for use on the pet leash belt having hook or clip fasteners on both ends of the leash.

8. The pet leash belt of claim 2 further comprising a leash configured specifically for use on the pet leash belt having hook or clip fasteners on both ends of the leash.

9. The pet leash belt of claim 3 further comprising a leash configured specifically for use on the pet leash belt having hook or clip fasteners on both ends of the leash.

10. The pet leash belt of claim 1 wherein the belt is constructed of double stitched and reinforced nylon material.

11. The pet leash belt of claim 2 wherein the belt is constructed of double stitched and reinforced nylon material.

12. The pet leash belt of claim 3 wherein the belt is constructed of double stitched and reinforced nylon material.

13. The pet leash belt of claim 1 sized appropriately to be worn around the waist or wrist of a human user.

14. The pet leash belt of claim 1 sized appropriately to be anchored around a tree or post.

15. The pet leash belt of claim 2 sized appropriately to be worn around the waist or wrist of a human user.

16. The pet leash of claim 2 sized appropriately to be anchored around a tree or post.

17. The pet leash belt of claim 3 sized appropriately to be worn around the waist or wrist of a human user.

18. The pet leash belt of claim 3 sized appropriately to be anchored around a tree or post.

19. The pet leash belt of claim 1 produced in a range of sizes and widths to accommodate various body types and wearers.

20. The pet leash belt of claim 1 produced in a variety of attractive colors and neutral hues.
